(19) United States
(12) Patent Application Publication
(10) Pub. No.: US 2025/0253761 A1
(43) Pub. Date: Aug. 7, 2025

(54) SEMICONDUCTOR DEVICE

(71) Applicant: FUJI ELECTRIC CO., LTD., Kawasaki-shi (JP)

(72) Inventor: Shigemi MIYAZAWA, Matsumoto-city (JP)

(73) Assignee: FUJI ELECTRIC CO., LTD., Kawasaki-shi (JP)

(21) Appl. No.: 19/001,951

(22) Filed: Dec. 26, 2024

(30) Foreign Application Priority Data
Feb. 2, 2024 (JP) 2024-014829

(51) Int. Cl. H02M 1/32; H02M 7/539

(52) U.S. Cl. CPC H02M 1/32; H02M 7/539

(57) ABSTRACT

A semiconductor device is configured to be controlled by a control unit. The semiconductor device includes: an upper arm switching element; a lower arm switching element serially connected to the upper arm switching element; an upper arm control circuit that executes drive control on the upper arm switching element based on an upper arm drive signal received from the control unit; an overvoltage detection circuit that detects an overvoltage state of the upper arm control circuit and outputs an overvoltage detection signal; and a lower arm control circuit that executes drive control on the lower arm switching element, based on a lower arm drive signal received from the control unit or based on the overvoltage detection signal.

### CROSS-REFERENCE TO RELATED APPLICATION

This application is based upon and claims the benefit of priority of the prior Japanese Patent Application No. 2024-014829, filed on Feb. 2, 2024, the entire contents of which are incorporated herein by reference.

### BACKGROUND OF THE INVENTION

### 1. Field of the Invention

The present embodiment discussed herein relates to a semiconductor device.

### 2. Background of the Related Art

An inverter device for driving a motor includes upper arm switching elements for controlling currents flowing through the coils inside the motor and a drive circuit (high voltage integrated circuit (HVIC)) for controlling ON/OFF of the upper arm switching elements.

As a related technique, for example, there has been proposed a technique that prevents a surge current from flowing into a low side switching drive circuit by providing resistors between an input buffer and a power supply and that protects a high side switching drive circuit from a negative surge generated by self-inductance of wirings (Japanese Laid-open Patent Publication No. 2004-72942). In addition, there has been proposed a technique that prevents application of an overvoltage by using an overvoltage protection Zener diode inserted between a high-voltage-side control power supply terminal and a low-voltage-side control power supply terminal and that prevents chain destruction in an inverter circuit (Japanese Laid-open Patent Publication No. 2008-148511).

### SUMMARY OF THE INVENTION

In an aspect of the present embodiment, there is provided a semiconductor device configured to be controlled by a control unit. The semiconductor device includes: an upper arm switching element; a lower arm switching element serially connected to the upper arm switching element; an upper arm control circuit that executes drive control on the upper arm switching element based on an upper arm drive signal received from the control unit; an overvoltage detection circuit that detects an overvoltage state of the upper arm control circuit and outputs an overvoltage detection signal; and a lower arm control circuit that executes drive control on the lower arm switching element, based on a lower arm drive signal received from the control unit or based on the overvoltage detection signal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 illustrates an example of a semiconductor device;

FIG. 2 illustrates a configuration example of an inverter device;

FIG. 3 illustrates a configuration example of a semiconductor drive device;

FIG. 4 illustrates an internal configuration example of a semiconductor control device;

FIG. 5 illustrates an example of the connection state between the semiconductor control device and coils;

FIG. 6 illustrates a configuration example of an upper arm control circuit;

FIG. 7 illustrates a configuration example of a control circuit;

FIG. 8 illustrates a configuration example of a drive circuit;

FIG. 9 illustrates a configuration example of a lower arm control circuit;

FIG. 10 illustrates a configuration example of an inverter circuit;

FIG. 11 illustrates a configuration example of an inverter circuit;

FIG. 12 illustrates a configuration example of a NAND circuit;

FIG. 13 illustrates a configuration example of a NOR circuit;

FIG. 14 illustrates a configuration example of a comparator;

FIG. 15 illustrates a configuration example of a reference voltage circuit;

FIG. 16 illustrates an example of the relationship between switching element drive signals and currents flowing through the coils;

FIG. 17 illustrates an example of timings in a switching operation;

FIG. 18 illustrates an example of timings in a switching operation;

FIG. 19 illustrates an example of the cross-sectional structure of a main portion of an upper arm control circuit; and

FIG. 20 illustrates an example of the mounting structure of the semiconductor control device.

### DETAILED DESCRIPTION OF THE INVENTION

Hereinafter, the present embodiment will be described with reference to the drawings. In the present description and drawings, elements having substantially the same configuration will be denoted by the same reference characters, and redundant description thereof will be omitted as appropriate. In addition, in the present description, unless otherwise noted, “connection” means “electrical connection”. Furthermore, when the logic level of a voltage or a signal indicates a low potential level, an expression “Lo level” will be used. In addition, when the logic level of a voltage or a signal indicates a high potential level, an expression “Hi level” will be used. In addition, the ground potential is a reference potential for the entire system including a semiconductor device, and is 0 V (GND).

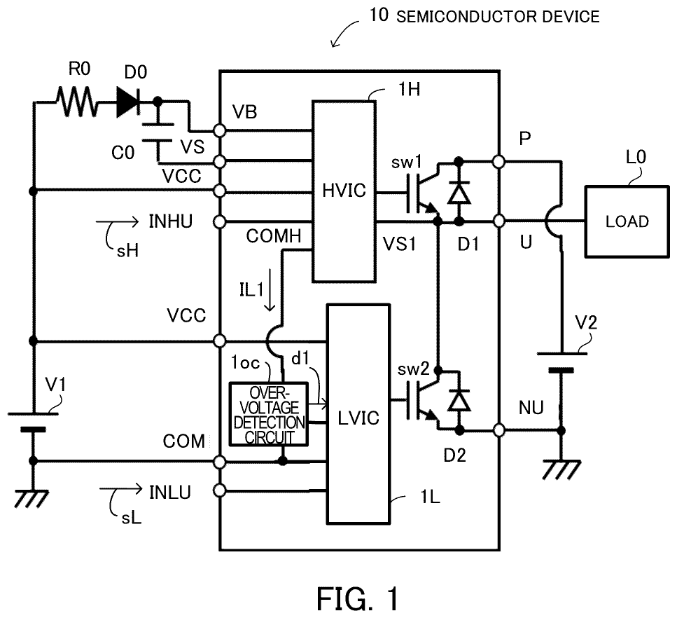

FIG. 1 illustrates an example of a semiconductor device. This semiconductor device 10 includes an upper arm control circuit (HVIC) 1H, a lower arm control circuit (low voltage integrated circuit (LVIC)) 1L, an upper arm switching element sw1, a lower arm switching element sw2, diodes D1 and D2, and an overvoltage detection circuit 1oc. In addition, the semiconductor device 10 includes power supplies V1 and V2, a resistor R0, a diode D0, and a capacitor CO, and is connected to a load LO. The semiconductor device 10 is applied, for example, to an intelligent power module (IPM) widely used for automotive electrical systems.

The upper arm control circuit 1H includes a terminal VB, a terminal VS, a terminal VCC, a terminal INHU, a terminal COMH, and a terminal VS1. The lower arm control circuit 1L includes a terminal VCC, a terminal COM, and a terminal INLU.

The upper arm control circuit 1H executes drive control on the upper arm switching element sw1 that operates the load LO, based on an upper arm drive signal sH input to the terminal INHU. The overvoltage detection circuit 1oc determines whether the upper arm control circuit 1H is in an overvoltage state. If the overvoltage detection circuit 1oc determines that the upper arm control circuit 1H is in an overvoltage state, the overvoltage detection circuit 1oc outputs an overvoltage detection signal d1.

The lower arm control circuit 1L executes drive control on the lower arm switching element sw2 serially connected to the upper arm switching element sw1, based on a lower arm drive signal sL input to the terminal INLU or based on the overvoltage detection signal d1.

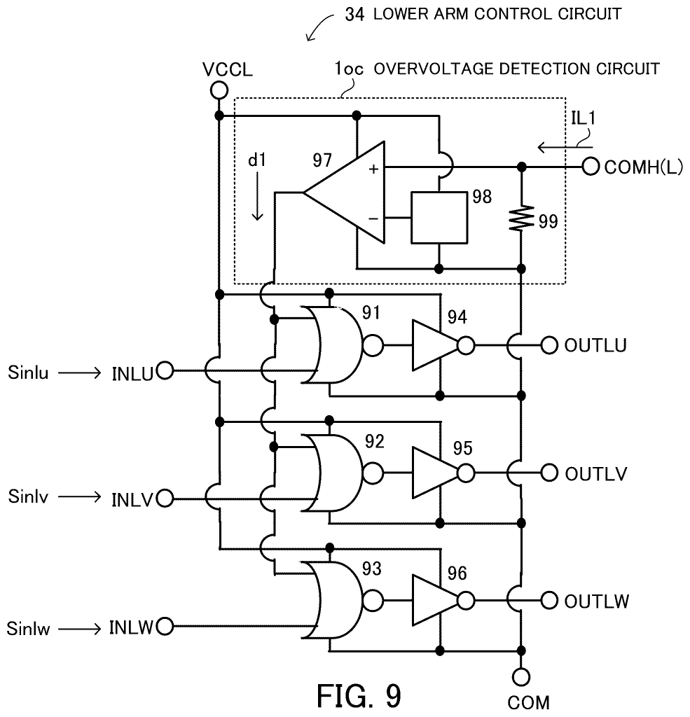

The upper arm drive signal sH and the lower arm drive signal sL are transmitted from a control unit 12 (for example, a microcomputer). As will be illustrated in FIG. 9, which will be described below, the overvoltage detection circuit 1oc may be included in the lower arm control circuit 1L.

The positive terminal of the power supply V1 is connected to one end of the resistor R0, the upper-arm-side terminal VCC, and the lower-arm-side terminal VCC. The negative terminal of the power supply V1 is connected to the terminal COM and a reference potential (which will be hereinafter referred to as GND as appropriate).

The other end of the resistor R0 is connected to the anode of the diode D0, and the cathode of the diode D0 is connected to one end of the capacitor CO and the terminal VB. The other end of the capacitor CO is connected to the terminal VS.

The resistor R0, the diode D0, and the capacitor CO constitute a bootstrap circuit that supplies a voltage for driving the gate of the upper arm switching element sw1. Thus, the upper arm control circuit 1H executes drive control on the upper arm switching element sw1 based on a drive power supply voltage between the high-potential-side drive power supply voltage (the voltage of the terminal VB) at a floating potential and the low-potential-side drive power supply voltage (the voltage of the terminal VS).

The upper arm switching element sw1 is connected in anti-parallel with the diode D1 (a first diode), and the lower arm switching element sw2 is connected in anti-parallel with the diode D2 (a second diode).

The high potential terminal (a first high potential terminal) of the upper arm switching element sw1 is connected to the cathode of the diode D1 and a high-potential-side power supply terminal (a terminal P) connected to the positive terminal of the power supply V2.

The low-potential terminal (a first low-potential terminal) of the upper arm switching element sw1 is connected to: the low-potential-side drive power supply terminal (the terminal VS1) to which the low-potential-side drive power supply voltage (the voltage of the terminal VS) is applied; an output terminal (a terminal U) connected to the load LO; the anode of the diode D1; the high potential terminal (a second high potential terminal) of the lower arm switching element sw2; and the cathode of the diode D2.

The low-potential terminal (a second low-potential terminal) of the lower arm switching element sw2 is connected to the anode of the diode D2, the negative terminal of the power supply V2, and a low-potential-side power supply terminal (a terminal NU) connected to the GND. The terminal COMH is connected to the negative terminal of the power supply V1 and the GND via the overvoltage detection circuit 1oc and the terminal COM.

When the overvoltage detection signal d1 is output from the overvoltage detection circuit 1oc, the lower arm switching element sw2 turns on, the terminal VS1 is electrically connected to the terminal NU, and the drive power supply voltage applied to the upper arm control circuit 1H drops.

When the lower arm switching element sw2 turns on while the upper arm switching element sw1 is off, the potential (the collector potential) of the high potential terminal of the lower arm switching element sw2 becomes approximately equal to the reference potential (GND) of the device.

Next, when the lower arm switching element sw2 turns off, the collector potential of the lower arm switching element sw2 sharply rises. If the collector potential exceeds the power supply potential of the device, the current flowing through the lower arm switching element sw2 begins to flow through the upper-arm-side diode D1.

In this transient state in which the current beings to flow through the diode D1, because the operating resistance of the diode D1 is large, the collector potential of the lower arm switching element sw2 is larger than the power supply potential of the device. In this state, the collector-emitter voltage of the lower arm switching element sw2 and the voltage between the terminal VB and the terminal COMH of the upper arm control circuit 1H become maximum. In this case, if the withstand voltage of the upper arm control circuit 1H is less than the withstand voltage of the switching element, the upper arm control circuit 1H may be destroyed.

Thus, to prevent destruction of the upper arm control circuit 1H even in an overvoltage state in which a voltage larger than the withstand voltage of the switching element is applied, it is conceivable that the upper arm control circuit 1H is configured to have a high withstand voltage. However, it is technically difficult to configure the upper arm control circuit 1H such that the elements thereof have a high withstand voltage. In addition, for example, because the area of the semiconductor substrate is increased, the manufacturing cost will be increased.

On the other hand, if the voltage between the terminal VB and the terminal COMH of the upper arm control circuit 1H exceeds a predetermined withstand voltage, a current (leakage current IL1) flows from the terminal VB (floating potential) to the terminal COMH (ground potential), and a larger leakage current IL1 flows from the terminal COMH.

Thus, the semiconductor device 10 according to the present embodiment is configured as follows. That is, in addition to the drive control on the lower arm switching element sw2 based on the lower arm drive signal sL input to the terminal INLU, when the overvoltage detection circuit 1oc detects an overvoltage state of the upper arm control circuit 1H based on the leakage current IL1, the lower arm switching element sw2 is turned on based on the overvoltage detection signal d1 output in the overvoltage state.

With this control process as described above, when the upper arm control circuit 1H is in an overvoltage state, the lower arm switching element sw2 turns on, and the increase of the VB voltage of the terminal VB is prevented (the increase of the voltage applied to the terminal U is also prevented). Thus, the leakage current IL1 between the terminal VB and the terminal COMH is reduced and maintained at a constant level, and the overvoltage state of the upper arm control circuit 1H is resolved, thereby achieving overvoltage protection. In this way, it is possible to achieve a higher withstand voltage without needing a structural design for the surge withstand of the upper arm control circuit 1H.

### <Overview of Inverter Device Using Semiconductor Device>

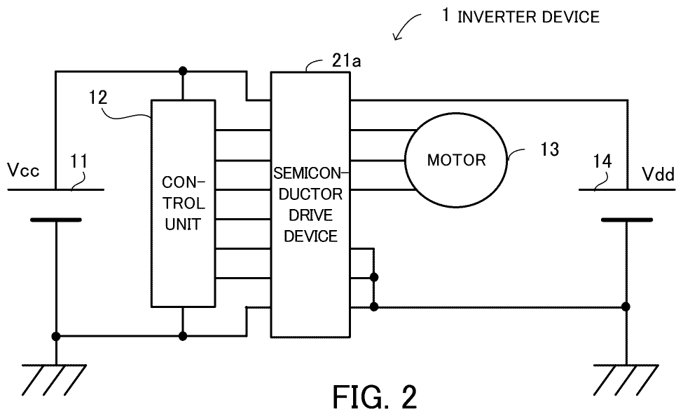

Hereinafter, the present embodiment will be described in detail. FIG. 2 illustrates a configuration example of an inverter device. This inverter device 1 includes a power supply 11, a control unit 12, a motor 13, a power supply 14, and a semiconductor drive device 21a having the function of the semiconductor device 10.

The power supply 11 supplies a power supply voltage Vcc, and is, for example, an automobile battery having a Vcc of 15 V. The control unit 12 is, for example, an electronic control unit (ECU) of an automobile. The motor 13 corresponds to the load LO, and is, for example, a three-phase alternating-current (AC) motor. The power supply 14 supplies a power supply voltage Vdd, and is, for example, an automobile battery having a Vdd of 400 V. The semiconductor drive device 21a drives the motor 13 based on upper arm or lower arm drive signals output from the control unit 12.

<Configuration Example of Semiconductor Drive Device 21a>

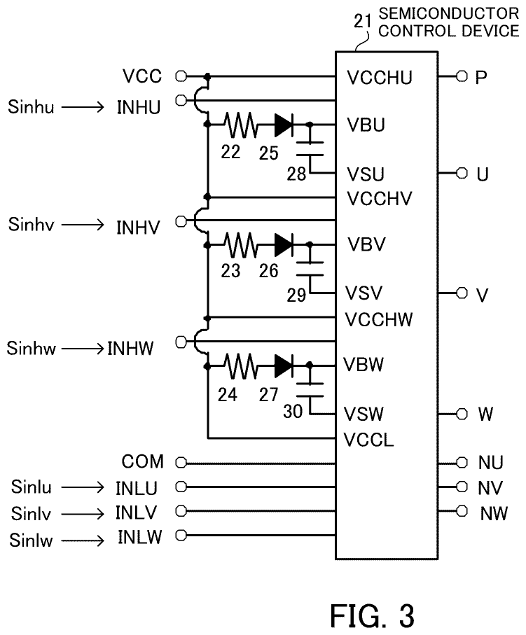

FIG. 3 illustrates a configuration example of the semiconductor drive device. The semiconductor drive device 21a illustrated in FIG. 2 includes a semiconductor control device 21, resistors 22, 23, and 24, diodes 25, 26, and 27, and capacitors 28, 29, and 30.

In addition, the semiconductor control device 21 includes a terminal VCC, which is a power supply terminal, a terminal P, and a terminal COM, which is a common ground terminal. The terminal VCC is connected to the positive terminal of the power supply 11 in FIG. 2, and the terminal P is connected to the positive terminal of the power supply 14 in FIG. 2. The terminal COM is connected to a GND.

In addition, the semiconductor control device 21 includes a terminal INHU (a high-side U-phase input terminal), a terminal INHV (a high-side V-phase input terminal), a terminal INHW (a high-side W-phase input terminal), a terminal INLU (a low-side U-phase input terminal), a terminal INLV (a low-side V-phase input terminal), and a terminal INLW (a low-side W-phase input terminal).

The terminal INHU, the terminal INHV, and the terminal INHW receive high-side upper arm drive signals Sinhu, Sinhv, and Sinhw, respectively, output from the control unit 12. The terminal INLU, the terminal INLV, and the terminal INLW receive low-side lower arm drive signals Sinlu, Sinlv, and Sinlw, respectively, output from the control unit 12.

In addition, the semiconductor control device 21 includes a terminal U (a U-phase output terminal), a terminal V (a V-phase output terminal), a terminal W (a W-phase output terminal), a terminal NU (an inverting U-phase output terminal), a terminal NV (an inverting V-phase output terminal), and a terminal NW (an inverting W-phase output terminal), which are for operating the motor 13. The terminal U, the terminal V, and the terminal W are connected to the motor 13, and the terminal NU, the terminal NV, and the terminal NW are connected to the GND.

Furthermore, the semiconductor control device 21 includes a terminal VCCHU (a high-side U-phase power supply terminal), a terminal VCCHV (a high-side V-phase power supply terminal), a terminal VCCHW (a high-side W-phase power supply terminal), and a terminal VCCL (a low-side power supply terminal).

In addition, the semiconductor control device 21 includes a terminal VBU (a high-side U-phase drive power supply terminal), a terminal VBV (a high-side V-phase drive power supply terminal), a terminal VBW (a high-side W-phase drive power supply terminal), a terminal VSU (a high-side U-phase low potential terminal), a terminal VSV (a high-side V-phase low potential terminal), and a terminal VSW (a high-side W-phase low potential terminal).

The connection relationship among the resistors 22, 23, and 24, the diodes 25, 26, and 27, and the capacitors 28, 29, and 30 will be described. One end of the resistor 22 is connected to the terminal VCC, the terminal VCCHU, the terminal VCCHV, one end of the resistor 23, the terminal VCCHW, one end of the resistor 24, and the terminal VCCL.

The other end of the resistor 22 is connected to the anode of the diode D25, and the cathode of the diode D25 is connected to the terminal VBU and one end of the capacitor 28. The other end of the capacitor 28 is connected to the terminal VSU.

The other end of the resistor 23 is connected to the anode of the diode D26, and the cathode of the diode D26 is connected to the terminal VBV and one end of the capacitor 29. The other end of the capacitor 29 is connected to the terminal VSV.

The other end of the resistor 24 is connected to the anode of the diode D27, and the cathode of the diode D27 is connected to the terminal VBW and one end of the capacitor 30. The other end of the capacitor 30 is connected to the terminal VSW.

The above-described resistor 22, diode 25 and capacitor 28 constitute a U-phase-side bootstrap circuit. The above-described resistor 23, diode 26 and capacitor 29 constitute a V-phase-side bootstrap circuit. The above-described resistor 24, diode 27 and capacitor 30 constitute a W-phase-side bootstrap circuit. When the potentials of the terminal VSU, the terminal VSV, and the terminal VSW are at a Lo level, the capacitors 28, 29, and 30 are charged with a voltage equal to the power supply voltage Vcc.

### <Internal Configuration Example of Semiconductor Control Device 21>

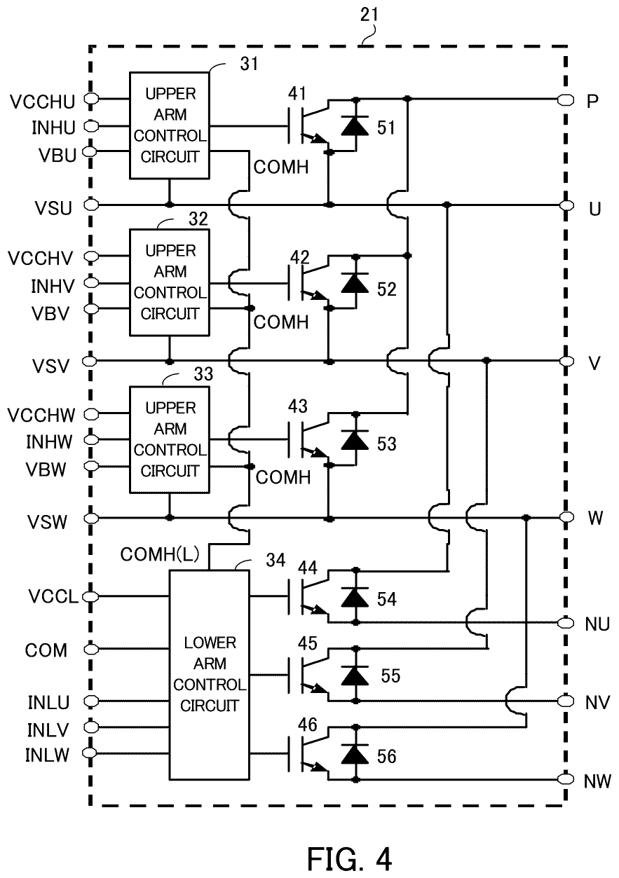

FIG. 4 illustrates an internal configuration example of the semiconductor control device. The semiconductor control device 21 includes upper arm control circuits 31, 32, and 33, a lower arm control circuit 34, switching elements 41, 42, 43, 44, 45, and 46, and free-wheeling diodes (FWDs) 51, 52, 53, 54, 55, and 56.

The switching elements 41, 42, 43, 44, 45, and 46 are, for example, insulated gate bipolar transistors (IGBTs) Alternatively, power metal-oxide-semiconductor field-effect transistors (MOSFETs) may be used. The switching elements 41, 42, 43, 44, 45, and 46 may also be referred to as IGBTs 41, 42, 43, 44, 45, and 46, respectively.

The upper arm control circuit 31 controls the current flowing through the switching element 41, and the upper arm control circuit 32 controls the current flowing through the switching element 42. The upper arm control circuit 33 controls the current flowing through the switching element 43. In addition, the lower arm control circuit 34 controls the current flowing through the switching elements 44, 45, and 46.

Herein, the gate of the switching element 41 is connected to the output terminal of the upper arm control circuit 31. The high potential terminal of the switching element 41 is connected to the high potential terminal of the switching element 42, the high potential terminal of the switching element 43, the cathode of the FWD 51, the cathode of the FWD 52, the cathode of the FWD 53, and the terminal P.

The low-potential terminal of the switching element 41 is connected to the terminal VSU, the anode of the FWD 51, the terminal U, the high potential terminal of the switching element 44, and the cathode of the FWD 54.

The gate of the switching element 42 is connected to the output terminal of the upper arm control circuit 32. The low-potential terminal of the switching element 42 is connected to the terminal VSV, the anode of the FWD 52, the terminal V, the high potential terminal of the switching element 45, and the cathode of the FWD 55.

The gate of the switching element 43 is connected to the output terminal of the upper arm control circuit 33. The low-potential terminal of the switching element 43 is connected to the terminal VSW, the anode of the FWD 53, the terminal W, the high potential terminal of the switching element 46, and the cathode of the FWD 56.

The gate of switching element 44 is connected to a first output terminal of the lower arm control circuit 34, and the low-potential terminal of the switching element 44 is connected to the anode of the FWD 54 and the terminal NU. The gate of the switching element 45 is connected to a second output terminal of the lower arm control circuit 34, and the low-potential terminal of the switching element 45 is connected to the anode of the FWD 55 and the terminal NV.

The gate of the switching element 46 is connected to a third output terminal of the lower arm control circuit 34, and the low-potential terminal of the switching element 46 is connected to the anode of the FWD 56 and the terminal NW. Each of the upper arm control circuits 31, 32, and 33 includes a terminal COMH, and the lower arm control circuit 34 includes a terminal COMH(L). The terminals COMH and the terminal COMH(L) are connected to each other. In addition, the terminal COMH is connected to the GND via the terminal COMH(L), a resistor in the lower arm control circuit 34, and the terminal COM (which will be described with reference to FIG. 9).

### <Connection State Between Semiconductor Control Device and Coils>

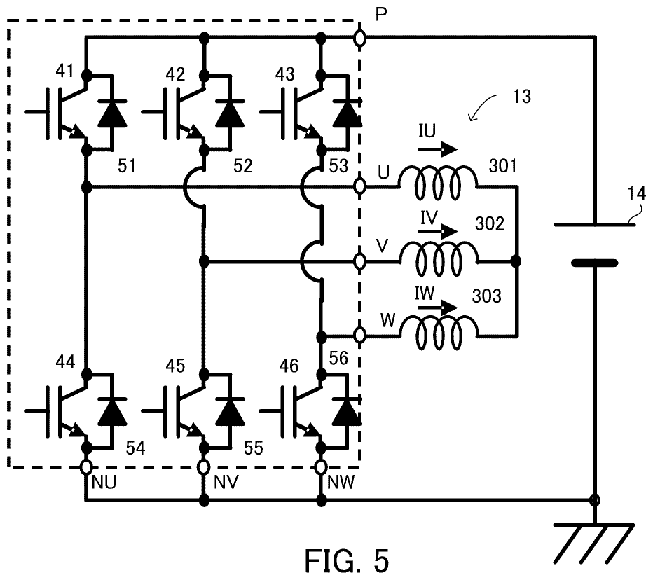

FIG. 5 illustrates an example of the connection state between the semiconductor control device and coils. The motor 13 is a three-phase AC motor, and includes a U-phase coil 301, a V-phase coil 302, and a W-phase coil 303.

One end of the U-phase coil 301 is connected to the terminal U, one end of the V-phase coil 302 is connected to the terminal V, and one end of the W-phase coil 303 is connected to the terminal W. In addition, the other end of the U-phase coil 301 is connected to the other end of the V-phase coil 302 and the other end of the W-phase coil 303. A current IU flows through the U-phase coil 301 via the terminal U, a current IV flows through the V-phase coil 302 via the terminal V, and a current IW flows through the W-phase coil 303 via the terminal W.

### <Configuration Example of Upper Arm Control Circuit 31>

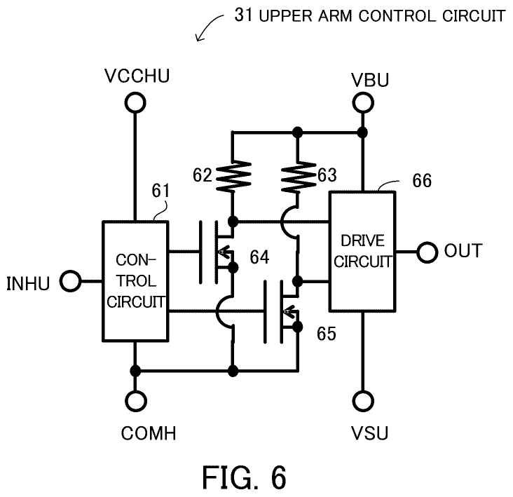

FIG. 6 illustrates a configuration example of an upper arm control circuit. Because the upper arm control circuits 31, 32, and 33 have the same configuration, the upper arm control circuit 31 will be described. The upper arm control circuit 31 includes a control circuit 61, a drive circuit 66, resistors 62 and 63, and switching elements 64 and 65, and is configured on one chip. NMOS transistors are used for the switching elements 64 and 65. The switching elements 64 and 65 may also be referred to as NMOS transistors 64 and 65 as well as MOS transistors 64 and 65, respectively.

The terminal VCCHU is connected to the power supply terminal of the control circuit 61. The terminal INHU is connected to the input terminal of the control circuit 61. A first output terminal of the control circuit 61 is connected to the gate of the switching element 64, and a second output terminal of the control circuit 61 is connected to the gate of the switching element 65.

The terminal VBU is connected to one end of the resistor 62, one end of the resistor 63, and the power supply terminal of the drive circuit 66. The other end of the resistor 62 is connected to the drain of the switching element 64 and a first input terminal of the drive circuit 66, and the other end of the resistor 63 is connected to the drain of the switching element 65 and a second input terminal of the drive circuit 66.

The terminal COMH is connected to the reference potential terminal of the control circuit 61, the source of the switching element 64, and the source of the switching element 65. In addition, the output terminal of the drive circuit 66 is connected to a terminal OUT, and the reference potential terminal of the drive circuit 66 is connected to the terminal VSU.

The resistor 62 and the switching element 64 function as a level-shift circuit. The resistor 63 and the switching element 65 also function as a level-shift circuit. When the gate voltage of the switching element 64 or 65 is at a Hi level, the drain voltage of the switching element 64 or 65 is at the same potential as that of the terminal COMH. When the gate voltage of the switching element 64 or 65 is at a Lo level, the drain voltage of the switching element 64 or 65 is at the same potential as that of the terminal VBU.

### <Configuration Example of Control Circuit 61>

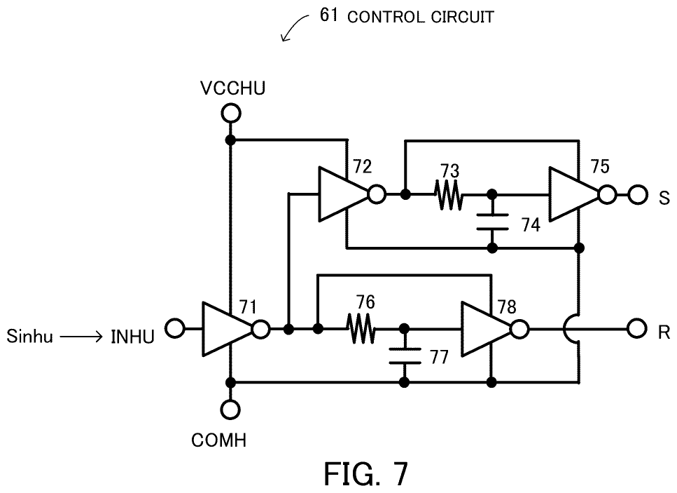

FIG. 7 illustrates a configuration example of the control circuit. The control circuit 61 includes a terminal VCCHU, a terminal COMH, a terminal INHU, a terminal S, a terminal R, inverter circuits 71, 72, 75, and 78, resistors 73 and 76, and capacitors 74 and 77.

The terminal VCCHU is connected to the power supply terminal of each of the inverter circuits 71 and 72. The terminal INHU to which the upper arm drive signal Sinhu is input from the control unit 12 is connected to the input terminal of the inverter circuit 71. The output terminal of the inverter circuit 71 is connected to the input terminal of the inverter circuit 72, one end of the resistor 76, and the power supply terminal of the inverter circuit 78. The output terminal of the inverter circuit 72 is connected to one end of the resistor 73 and the power supply terminal of the inverter circuit 75.

The other end of the resistor 73 is connected to one end of the capacitor 74 and the input terminal of the inverter circuit 75. The other end of the resistor 76 is connected to one end of the capacitor 77 and the input terminal of the inverter circuit 78. The other end of the capacitor 74 is connected to the reference potential terminal of the inverter circuit 72, the reference potential terminal of the inverter circuit 75, the reference potential terminal of the inverter circuit 78, the other end of the capacitor 77, the reference potential terminal of the inverter circuit 71, and the terminal COMH. The output terminal of the inverter circuit 75 is connected to the terminal S, and the output terminal of the inverter circuit 78 is connected to the terminal R.

The resistor 73 and the capacitor 74 constitute a delay circuit. The resistor 76 and the capacitor 77 also constitute a delay circuit. When the output voltage level of the inverter circuits 71 and 72 changes, the input voltage level of the inverter circuits 75 and 78 changes with a delay.

The control circuit 61 outputs a pulse signal when the upper arm drive signal Sinhu output from the control unit 12 is input to the terminal INHU. For example, when the voltage of the signal Sinhu exceeds 2.5 V, a Hi-level voltage pulse is output from the terminal S. The voltage pulse drops to a Lo level after a certain period of time (for example, 0.1 ρs).

When the voltage of the signal Sinhu falls below 2.5 V, a Hi-level voltage pulse is output from the terminal R. When the voltage level of the signal Sinhu does not change, the voltage level of the terminal S and terminal R is a Lo level.

### <Configuration Example of Drive Circuit 66>

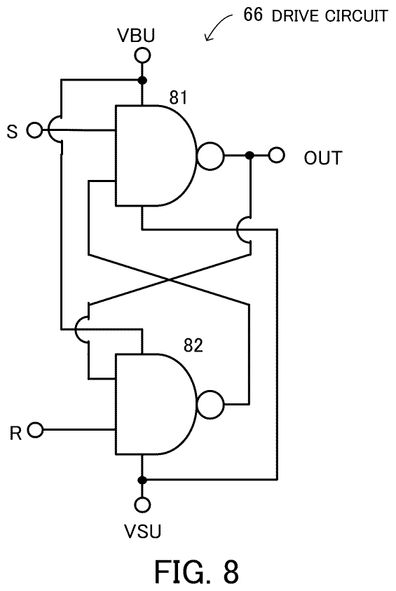

FIG. 8 illustrates a configuration example of the drive circuit. The drive circuit 66 includes a terminal VBU, a terminal VSU, a terminal S, a terminal R, a terminal OUT, and NAND circuits 81 and 82.

The terminal VBU is connected to the power supply terminal of the NAND circuit 81 and the power supply terminal of the NAND circuit 82. The terminal VSU is connected to the reference potential terminal of the NAND circuit 81 and the reference potential terminal of the NAND circuit 82.

The terminal S is connected to the first input terminal of the NAND circuit 81, and the terminal R is connected to the first input terminal of the NAND circuit 82. The output terminal of the NAND circuit 81 is connected to the terminal OUT and the second input terminal of the NAND circuit 82. The output terminal of the NAND circuit 82 is connected to the second input terminal of the NAND circuit 81.

Herein, the drive circuit 66 functions as a reset-set (RS) latch circuit. In a steady state, the voltage level of the terminal S and the terminal R is a Hi level. When the signal Sinhu input to the terminal INHU of the control circuit 61 illustrated in FIG. 7 changes from a Lo level to a Hi level, a Lo-level pulse signal is input to the terminal S of the drive circuit 66, and the voltage level of the terminal OUT rises to a Hi level.

In addition, when the signal Sinhu input to the terminal INHU of the control circuit 61 illustrated in FIG. 7 changes from a Hi level to a Lo level, a Lo-level pulse signal is input to the terminal R of the drive circuit 66, and the voltage level of the terminal OUT drops to a Lo level. When the voltage of the terminal OUT is at a Hi level, the switching element 41 to which the terminal OUT is connected is ON. When the voltage of the terminal OUT is at a Lo level, the switching element 41 to which the terminal OUT is connected is OFF.

<Configuration Example of Lower Arm Control Circuit 34>

FIG. 9 illustrates a configuration example of the lower arm control circuit. The lower arm control circuit 34 includes a terminal VCCL, a terminal COM, a terminal COMH(L), a terminal INLU, a terminal INLV, a terminal INLW, a terminal OUTLU, a terminal OUTLV, a terminal OUTLW, NOR circuits 91, 92, and 93, inverter circuits 94, 95, and 96, a comparator 97, a reference voltage circuit 98, and a resistor 99. The circuit constituted by the comparator 97, the reference voltage circuit 98, and the resistor 99 constitutes the overvoltage detection circuit 1oc illustrated in FIG. 1.

The terminal VCCL is connected to the power supply terminal of each of the comparator 97, the reference voltage circuit 98, the NOR circuits 91, 92, and 93, and the inverter circuits 94, 95, and 96. The terminal COMH(L) is connected to the non-inverting input terminal (+) of the comparator 97 and one end of the resistor 99. The terminal COM is connected to the other end of the resistor 99, the reference potential terminal of the comparator 97, the reference potential terminal of the reference voltage circuit 98, the reference potential terminal of each of the inverter circuits 94, 95, and 96, and the reference potential terminal of each of the NOR circuits 91, 92, and 93.

The output terminal of the reference voltage circuit 98 is connected to the inverting input terminal (−) of the comparator 97. The output terminal of the comparator 97 is connected to the first input terminal of the NOR circuit 91, the first input terminal of the NOR circuit 92, and the first input terminal of the NOR circuit 93.

The terminal INLU to which the lower arm drive signal Sinlu is input is connected to the second input terminal of the NOR circuit 91, and the terminal INLV to which the lower arm drive signal Sinlv is input is connected to the second input terminal of the NOR circuit 92. In addition, the terminal INLW to which the lower arm drive signal Sinlw is input is connected to the second input terminal of the NOR circuit 93.

The output terminal of the NOR circuit 91 is connected to the input terminal of the inverter circuit 94, and the output terminal of the inverter circuit 94 is connected to the terminal OUTLU. The output terminal of the NOR circuit 92 is connected to the input terminal of the inverter circuit 95, and the output terminal of the inverter circuit 95 is connected to the terminal OUTLV. The output terminal of the NOR circuit 93 is connected to the input terminal of the inverter circuit 96, and the output terminal of the inverter circuit 96 is connected to the terminal OUTLW.

In addition, the terminal OUTLU is connected to the gate of the switching element 44, the terminal OUTLV is connected to the gate of the switching element 45, and the terminal OUTLW is connected to the gate of the switching element 46.

When the terminal INLU receives the lower arm drive signal Sinlu output from the control unit 12, the lower arm control circuit 34 turns on/off the switching element 44. Similarly, when the terminal INLV receives the lower arm drive signal Sinlv output from the control unit 12, the lower arm control circuit 34 turns on/off the switching element 45. Similarly, when the terminal INLW receives the lower arm drive signal Sinlw output from the control unit 12, the lower arm control circuit 34 turns on/off the switching element 46. In addition, when the voltage of the terminal COMH(L) exceeds the output voltage of the reference voltage circuit 88, the lower arm control circuit 34 turns on the switching elements 44, 45, and 46.

When the leakage current IL1 flows from the terminal COMH of the upper arm control circuits 31, 32, and 33 and the lower arm control circuit 34 receives the leakage current IL1 via the terminal COMH(L), the resistor 99 functions as an element for converting the leakage current IL1 into a voltage signal and detecting the magnitude of the leakage current IL1. The reference voltage circuit 98 outputs a reference voltage.

The comparator 97 compares the voltage signal with the reference voltage and determines whether the upper arm control circuits 31, 32, and 33 are in an overvoltage state. In this case, when the voltage signal is equal to or more than the reference voltage, the comparator 97 determines an overvoltage state, outputs a Hi-level overvoltage detection signal (which corresponds to the overvoltage detection signal d1 in FIG. 1) to the first input terminals of the NOR circuits 91, 92, and 93. If the upper arm control circuits 31, 32, and 33 are not in an overvoltage state, the comparator 97 outputs a Lo-level signal.

For example, when a normal circuit current is 1 mA, the resistance of the resistor 99 is set to 100Ω, and an abnormal value is set to 10 mA. Thus, if a current of 10 mA or more flows through the resistor 99, the comparator 97 outputs a Hi-level signal.

### <Switching Elements 41, 42, 43, 44, 45, and 46>

The switching elements 41, 42, 43, 44, 45, and 46 execute switching of the voltage applied from the power supply 14 to the motor 13. The switching elements 41, 42, 43, 44, 45, and 46 are, for example, high-withstand-voltage switching elements.

Each of the switching elements 41, 42, 43, 44, 45, and 46 according to the present embodiment is, for example, a vertical N-channel IGBT constituted by forming an emitter electrode on the front surface of a substrate and forming a collector electrode on the rear surface of the substrate. Each of the switching elements 41, 42, 43, 44, 45, and 46 is a switching element having, for example, an on-resistance of 10 mΩ and a withstand voltage of a few hundred of V.

The switching elements 41, 42, 43, 44, 45, and 46 are not limited to IGBTs. MOS transistors or bipolar transistors may alternatively be used.

### <Configuration Example of Inverter Circuit 71>

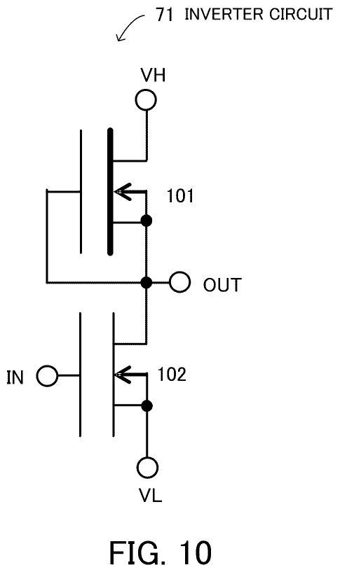

FIG. 10 illustrates a configuration example of the inverter circuit. The inverter circuit 71 includes a terminal IN, a terminal OUT, a terminal VH (a high-potential-side terminal), a terminal VL (a low-potential-side terminal), and MOS transistors 101 and 102.

The MOS transistors 101 and 102 are NMOS transistors. A depletion-mode NMOS transistor in which a current flows between the drain and the source when the gate-source voltage is 0 V is used as the MOS transistor 101. In the inverter circuit 71, the voltage level of the terminal IN is inverted, and the inverted voltage is output to the terminal OUT. Hereinafter, the MOS transistors 101 and 102 may also be referred to as NMOS transistors 101 and 102, respectively.

The terminal VH is connected to the drain of the NMOS transistor 101. The gate of the NMOS transistor 101 is connected to the source of the NMOS transistor 101, the terminal OUT, and the drain of the NMOS transistor 102. The terminal IN is connected to the gate of the NMOS transistor 102. The terminal VL is connected to the source of the NMOS transistor 102.

### <Configuration Example of Inverter Circuits 72, 75, 78, 94, 95, and 96>

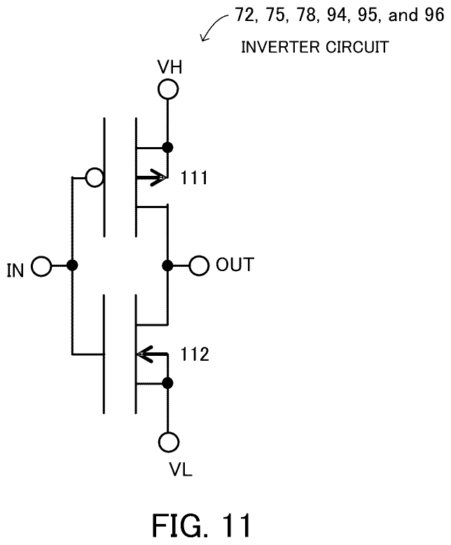

FIG. 11 illustrates a configuration example of an inverter circuit. Each of the inverter circuits 72, 75, 78, 94, 95, and 96 includes a terminal IN, a terminal OUT, a terminal VH (a high-potential-side terminal), a terminal VL (a low-potential-side terminal), and MOS transistors 111 and 112. The MOS transistor 111 is a PMOS transistor, and the MOS transistor 112 is an NMOS transistor. In each of the inverter circuits 72, 75, 78, 94, 95, 96, the voltage level of the terminal IN is inverted, and the inverted voltage is output to the terminal OUT. In the following description, the MOS transistor 111 may be called a PMOS transistor 111 and the MOS transistor 112 may be called a NMOS transistor 112.

The terminal IN is connected to the gate of the PMOS transistor 111 and the gate of the NMOS transistor 112. The terminal VH is connected to the source of the PMOS transistor 111. The drain of the PMOS transistor 111 is connected to the terminal OUT and the drain of the NMOS transistor 112. The terminal VL is connected to the source of the NMOS transistor 112.

### <Configuration Example of NAND Circuits 81 and 82>

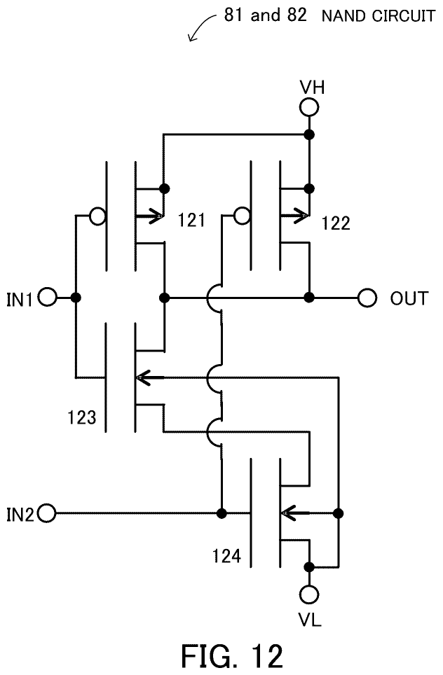

FIG. 12 illustrates a configuration example of a NAND circuit. Each of the NAND circuits 81 and 82 includes a terminal IN1, a terminal IN2, a terminal OUT, a terminal VH (a high-potential-side terminal), a terminal VL (a low-potential-side terminal), and MOS transistors 121, 122, 123, and 124. The MOS transistors 121 and 122 are PMOS transistors. The MOS transistors 123 and 124 are NMOS transistors. In the following description, the MOS transistors 121 and 122 may be called PMOS transistors, respectively, and the MOS transistors 123 and 124 may be called NMOS transistors 123 and 124, respectively.

The terminal IN1 is connected to the gate of the PMOS transistor 121 and the gate of the NMOS transistor 123. The terminal IN2 is connected to the gate of the PMOS transistor 122 and the gate of the NMOS transistor 124.

The terminal VH is connected to the source of the PMOS transistor 121 and the source of the PMOS transistor 122. The terminal OUT is connected to the drain of the PMOS transistor 121, the drain of the PMOS transistor 122, and the drain of the NMOS transistor 123.

The terminal VL is connected to the back gate of the NMOS transistor 123, the back gate of the NMOS transistor 124, and the source of the NMOS transistor 124. The source of the NMOS transistor 123 is connected to the drain of the NMOS transistor 124.

When both the voltage level of the terminal IN1 and the voltage level of the terminal IN2 are an Hi level, the voltage level of the terminal OUT is a Lo level. Otherwise, the voltage level of the terminal OUT is a Hi level.

### <Configuration Example of NOR Circuits 91, 92, and 93>

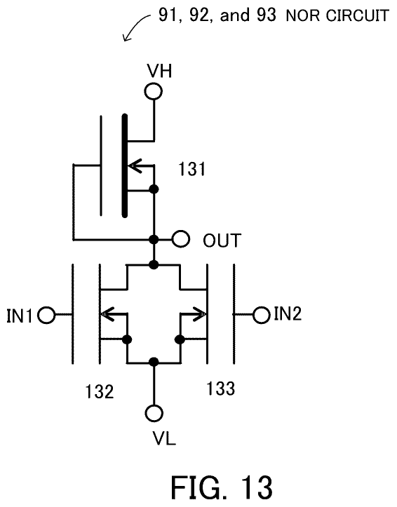

FIG. 13 illustrates a configuration example of a NOR circuit. Each of the NOR circuits 91, 92, and 93 includes a terminal IN1, a terminal IN2, a terminal OUT, a terminal VH (a high-potential-side terminal), a terminal VL (a low-potential-side terminal), and MOS transistors 131, 132, and 133. The MOS transistor 131, 132, and 133 are NMOS transistors, and the MOS transistor 131 is a depletion-mode NMOS transistor. Hereinafter, the MOS transistor 131, 132, and 133 may also be referred to as NMOS transistors 131, 132, and 133, respectively.

The terminal IN1 is connected to the gate of the NMOS transistor 132, and the terminal IN2 is connected to the gate of the NMOS transistor 133. The terminal VH is connected to the drain of the NMOS transistor 131. The terminal OUT is connected to the source of the NMOS transistor 131, the gate of the NMOS transistor 131, the drain of the NMOS transistor 132, and the drain of the NMOS transistor 133. The terminal VL is connected to the source of the NMOS transistor 132 and the source of the NMOS transistor 133.

When both the voltage level of the terminal IN1 and the voltage level of the terminal IN2 are a Lo level, the voltage level of the terminal OUT is a Hi level. Otherwise, the voltage level of the terminal OUT is a Lo level.

### <Configuration Example of Comparator 97>

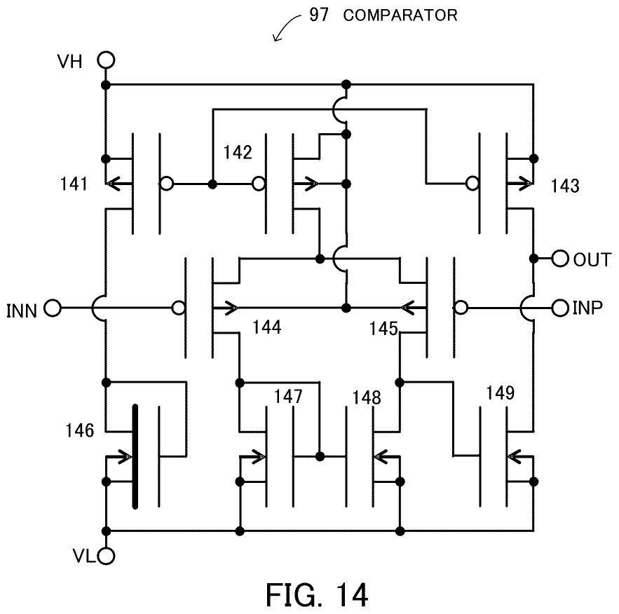

FIG. 14 illustrates a configuration example of the comparator. The comparator 97 includes a terminal INP (a non-inverting input terminal (+)), a terminal INN (an inverting input terminal (−)), a terminal OUT, a terminal VH (a high-potential-side terminal), a terminal VL (a low-potential-side terminal), and MOS transistors 141, 142, 143, 144, 145, 146, 147, 148, and 149.

The MOS transistors 141, 142, 143, 144, and 145 are PMOS transistors. The MOS transistors 146, 147, 148, and 149 are NMOS transistors, and the MOS transistor 146 is a depletion-mode NMOS transistor. Hereinafter, the MOS transistors 141, 142, 143, 144, and 145 may be referred to as PMOS transistors 141, 142, 143, 144, and 145, respectively, and the MOS transistors 146, 147, 148, and 149 may be referred to as NMOS transistors 146, 147, 148, and 149, respectively.

The terminal INP is connected to the gate of the PMOS transistor 145, and the terminal INN is connected to the gate of the PMOS transistor 144. The terminal VH is connected to the source of the PMOS transistor 141, the source of the PMOS transistor 142, the back gate of the PMOS transistor 142, the back gate of the PMOS transistor 144, the back gate of the PMOS transistor 145, and the source of the PMOS transistor 143.

The terminal VL is connected to the source of the NMOS transistor 146, the source of the NMOS transistor 147, the source of the NMOS transistor 148, and the source of the NMOS transistor 149.

The drain of the PMOS transistor 141 is connected to the drain of the NMOS transistor 146 and the gate of the NMOS transistor 146. The gate of the PMOS transistor 141 is connected to the gate of the PMOS transistor 142 and the gate of the PMOS transistor 143.

The drain of the PMOS transistor 142 is connected to the source of the PMOS transistor 144 and the source of the PMOS transistor 145. The drain of the PMOS transistor 144 is connected to the drain of the NMOS transistor 147, the gate of the NMOS transistor 147, and the gate of the NMOS transistor 148.

The drain of the PMOS transistor 145 is connected to the drain of the NMOS transistor 148 and the gate of the NMOS transistor 149. The terminal OUT is connected to the drain of the PMOS transistor 143 and the drain of the NMOS transistor 149.

The voltage level of the terminal INP is compared with the voltage level of the terminal INM. If the terminal INP is larger, the voltage level of the terminal OUT rises to a Hi level. Otherwise, the voltage level of the terminal OUT drops to a Lo level.

### <Configuration Example of Reference Voltage Circuit 98>

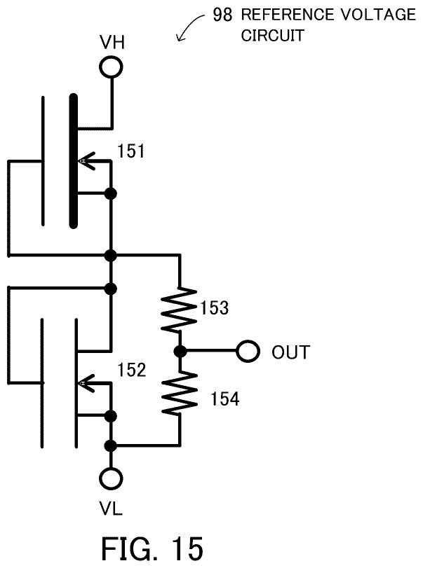

FIG. 15 illustrates a configuration example of the reference voltage circuit. The reference voltage circuit 98 includes a terminal OUT, a terminal VH (a high-potential-side terminal), a terminal VL (a low-potential-side terminal), MOS transistors 151 and 152, and resistors 153 and 154. The MOS transistors 151 and 152 are NMOS transistors, and the MOS transistor 151 is a depletion-mode NMOS transistor. Hereinafter, the MOS transistors 151 and 152 may be referred to as NMOS transistors 151 and 152, respectively.

The terminal VH is connected to the drain of the NMOS transistor 151. The gate of the NMOS transistor 151 is connected to the source of the NMOS transistor 151, the gate of the NMOS transistor 152, the drain of the NMOS transistor 152, and one end of the resistor 153. The terminal VL is connected to the source of the NMOS transistor 152 and one end of the resistor 154. The terminal OUT is connected to the other end of the resistor 153 and the other end of the resistor 154.

A voltage obtained by dividing the pinch-off voltage generated when the source current of the MOS transistor 151 flows through the MOS transistor 152 with the resistors 153 and 154 is output to the terminal OUT.

### <Relationship Between Switching Element Drive Signals and Currents Flowing Through Coils>

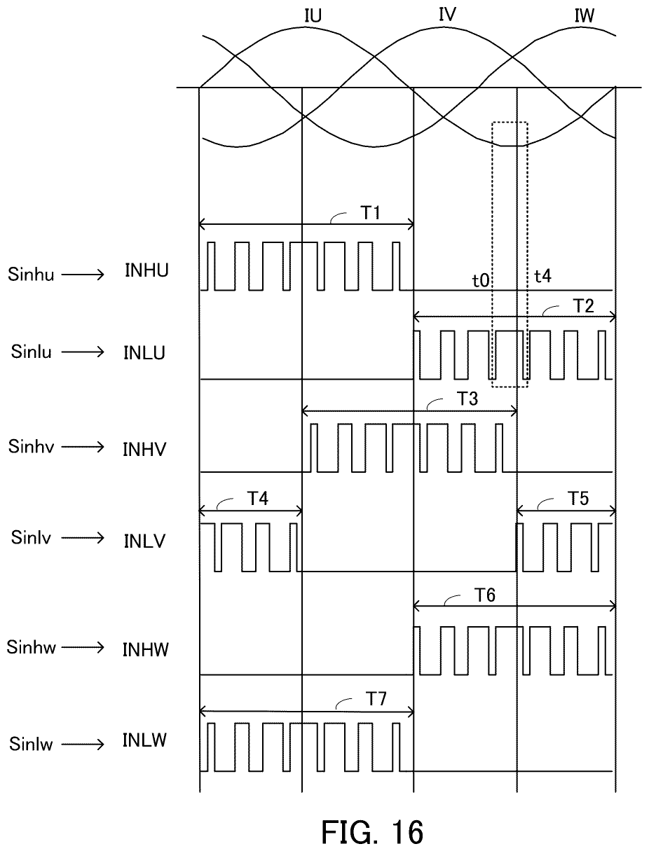

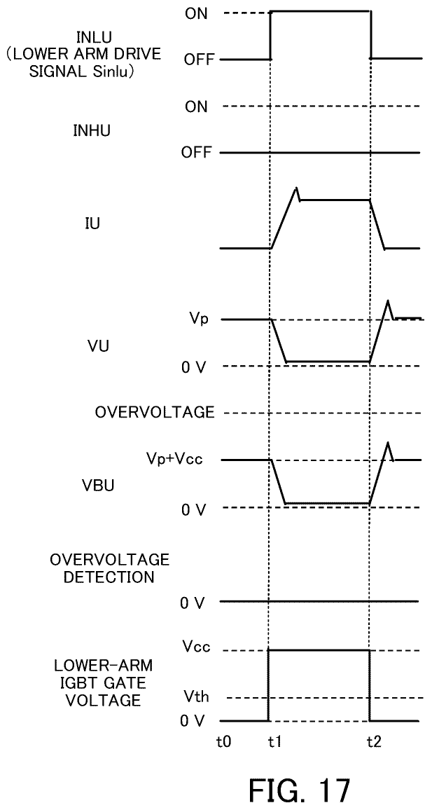

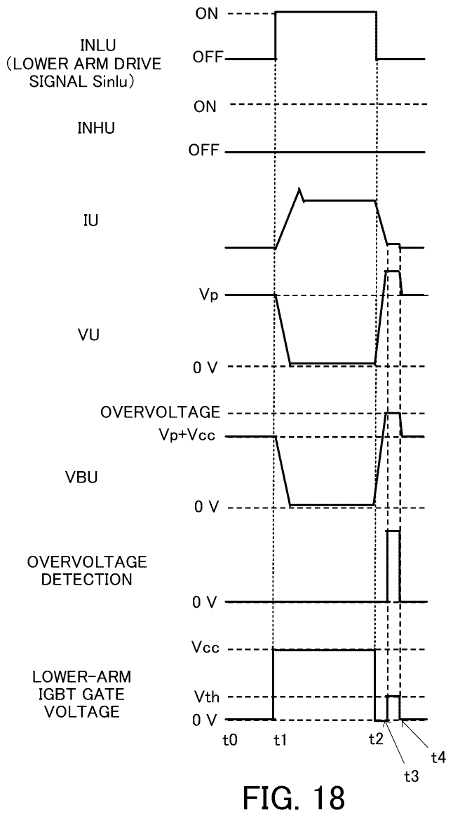

FIG. 16 illustrates an example of the relationship between the switching element drive signals and the currents flowing through the coils. The section from time t0 to time t4 in FIGS. 17 and 18, which will be described below, is illustrated in FIG. 16. Three-phase alternating-currents, which are out of phase with each other by 120°, flow through the U-phase coil 301, the V-phase coil 302, and the W-phase coil 303 of the motor 13, and rotate the motor 13.

In this case, in a section T1, the upper arm drive signal Sinhu is input to the terminal INHU, and the switching of the switching element 41 is driven. In a section T2, the lower arm drive signal Sinlu is input to the terminal INLU, and the switching of the switching element 44 is driven.

In addition, in a section T3, the upper arm drive signal Sinhv is input to the terminal INHV, and the switching of the switching element 42 is driven. In sections T4 and T5, the lower arm drive signal Sinlv is input to the terminal INLV, and the switching of the switching element 45 is driven.

In addition, in a section T6, the upper arm drive signal Sinhw is input to the terminal INHW, and the switching of the switching element 43 is driven. In a section T7, the lower arm drive signal Sinlw is input to the terminal INLW, and the switching of the switching element 46 is driven.

### <Timing of Switching Operation>

FIGS. 17 and 18 each illustrate an example of timings in a switching operation. FIG. 17 schematically illustrates an example of change in voltages and signals in the semiconductor control device 21 over time when the switching operation of the U phase of the semiconductor control device 21 is executed and when the maximum value of the U-phase VB voltage (VBU in FIG. 17) is less than the withstand voltage between the terminal VBU and the terminal COMH. The “switching operation” of the U phase of the semiconductor control device 21 refers to a case when the switching element 44 turns ON/OFF. In addition, assuming that the current flowing through the terminal NU is IU, the direction in which the current flowing from the terminal NU to the GND will be considered to be the positive direction. In addition, the section from t0 to t4 is illustrated in FIG. 18.

At time t0, the signals input from the control unit 12 to the terminals INLU and INHU are at a Lo level, and the switching elements 41 and 44 are in an off-state. In addition, because the current IU flowing through the U-phase coil 301 indicates a negative current value, the current flows through the terminal P from the terminal U via the FWD 51. Thus, a potential VU of the terminal U is approximately equal to a potential Vp of the power supply 14.

At time t1, to turn on the switching element 44, the control unit 12 increases the lower arm drive signal Sinlu input to the terminal INLU from a Lo level to a Hi level. When the switching element 44 turns on, the potential VU of the terminal U becomes equal to the potential of the terminal NU connected to the ground, and the VB potential (VBU) becomes approximately equal to the voltage Vcc of the power supply 11 via the resistor 22 and the diode 25.

At time t2, to turn off the switching element 44, the control unit 12 decreases the lower arm drive signal Sinlu input to the terminal INLU from a Hi level to a Lo level. Thus, the lower-arm IGBT gate voltage (the gate voltage of the switching element 44) in FIG. 17 represents a Hi level from time t1 to time t2.

Next, when the switching element 44 turns off, the potential VU of the terminal U becomes equal to the voltage Vp of the power supply 14, and the VB potential (VBU) becomes equal to Vcc+Vp. Thus, the maximum value of the U-phase VB voltage (VBU) remains less than the withstand voltage between the terminal VBU and the terminal COMH (less than the overvoltage level).

In this state, a current, which is considered to be a leakage current that flows when the upper arm control circuit is in an overvoltage state, is not input from the terminal COMH to the terminal COMH(L) of the lower arm control circuit 34. Thus, because the voltage of the terminal COMH(L) does not exceed the voltage (for example, 1 V) of the reference voltage circuit 98, the overvoltage detection level remains at 0 V.

FIG. 18 schematically illustrates an example of change in voltages and signals in the semiconductor control device 21 over time when the switching operation of the U phase of the semiconductor control device 21 is executed and when the maximum value of the U-phase VB voltage (VBU) is more than the withstand voltage between the terminal VBU and the terminal COMH.

From time t0 to time t1, the voltages and signals change in the say way as in FIG. 17. At time t2, when the lower arm drive signal Sinlu drops to a Lo level, the current IU begins to decrease, and the voltage VBU (the voltage of the terminal VBU) begins to increase. When the current IU is 0 and the voltage VBU comes close to Vp, the current flowing through the U-phase coil 301 connected to the terminal U begins to flow through the terminal P via the FWD 51. Immediately after the current flows through the FWD 51, because the operating resistance of the FWD 51 is large, the voltage VU and the voltage VBU are larger than the voltage Vp.

At time t3, when the voltage VBU becomes greater than the withstand voltage between the terminal VBU and the terminal COMH of the upper arm control circuit 31 (exceeds the overvoltage level), a current (the leakage current IL1) is input from the terminal COMH to the terminal COMH(L) of the lower arm control circuit 34.

The lower arm control circuit 34 converts the current input to the terminal COMH(L) into a voltage by using the resistor 99. If the voltage of the terminal COMH(L) exceeds the voltage of the reference voltage circuit 98 (for example, 1 V) (if the overvoltage detection level exceeds a predetermined level), the terminal OUTLU, the terminal OUTLV, and the terminal OUTLW output a Hi level signal.

The Hi level signal output from the terminal OUTLU, the terminal OUTLV, and the terminal OUTLW corresponds to the Hi level signal of the lower-arm IGBT gate voltage output from time t3 to time t4 in FIG. 18. This Hi level signal has a threshold voltage level of the switching elements 44, 45, and 46.

When the signal of the terminal OUTLU becomes a Hi level, the switching element 44 turns on, and the voltage VBU is clamped to be equal to the withstand voltage between the terminal VBU and the terminal COMH. Thus, the leakage current flowing between the terminal VBU and the terminal COMH is controlled, and the overvoltage state of the upper arm control circuit 31 is resolved. As a result, it is possible to prevent destruction of the upper arm control circuit 31.

Next, at time t4, when the operating resistance of the FWD 51 is reduced, the voltage VBU drops from the overvoltage level, and the voltage VU becomes approximately equal to the voltage Vp.

As described above, in the semiconductor control device 21, when a voltage greater than the withstand voltage between the terminal VB of the upper arm control circuits 31, 32, and 33 (in the example in FIGS. 17 and 18, the terminal VBU of the U-phase upper arm control circuit 31) and the terminal COMH is applied, the lower arm switching elements 44, 45, and 46 are turned on, and the VB voltage is controlled. As a result, it is possible to protect the upper arm control circuits 31, 32, and 33 from an excessively large voltage.

### <Structure of Upper Arm Control Circuit 31>

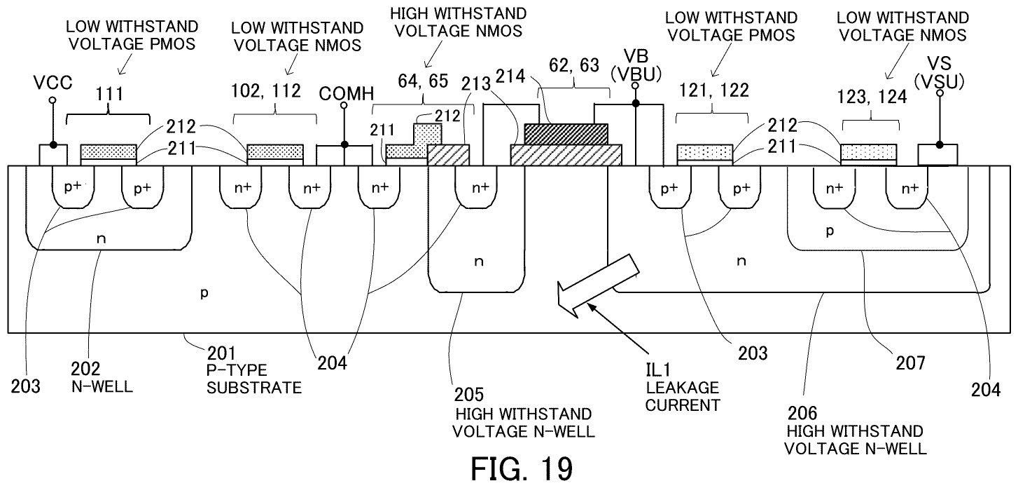

FIG. 19 illustrates an example of the cross-sectional structure of a main portion of an upper arm control circuit.

### (Structure of MOS Transistor 111 of Low Withstand Voltage PMOS)

An n-well 202 is formed on the front surface of a P-type substrate 201, and a gate oxide film 211 and a gate electrode 212 are accumulated on the n-well 202. Next, ion injection is executed by using the gate oxide film 211 and the gate electrode 212 as a mask, so as to form P⁺ layers 203, which function as a drain electrode and a source electrode.

### (Structure of MOS Transistors 102 and 112 of Low Withstand Voltage NMOS)

A gate oxide film 211 and a gate electrode 212 are accumulated on the P-type substrate 201. Next, ion injection is executed by using the gate oxide film 211 and the gate electrode 212 as a mask, so as to form n⁺ layers 204, which function as a drain electrode and a source electrode.

### (Structure of MOS Transistors 64 and 65 of High Withstand Voltage NMOS)

A high withstand voltage n-well 205 is formed on the front surface of the P-type substrate 201, and a gate oxide film 211, an insulating oxide film 213, and a gate electrode 212 are accumulated on the high withstand voltage n-well 205. Ion injection is executed by using the gate oxide film 211, the insulating oxide film 213, and the gate electrode 212 as a mask, so as to form n⁺ layers 204, which function as a drain electrode and a source electrode. The drain electrode of the MOS transistor 64 is connected to the terminal S, and the drain electrode of the MOS transistor 65 is connected to the terminal R.

### (Structure of MOS Transistors 121 and 122 of Low Withstand Voltage PMOS)

A high withstand voltage n-well 206 is formed on the front surface of the P-type substrate 201, and a gate oxide film 211 and a gate electrode 212 are accumulated on the high withstand voltage n-well 206. Ion injection is executed by using the gate oxide film 211 and the gate electrode 212 as a mask, so as to form P⁺ layers 203, which function as a drain electrode and a source electrode.

### (Structure of MOS Transistors 123 and 124 of Low Withstand Voltage NMOS)

A high withstand voltage n-well 206 is formed on the front surface of the P-type substrate 201, and a p-well 207 is formed on the front surface of the high withstand voltage n-well 206. A gate oxide film 211 and a gate electrode 212 are accumulated on the p-well 207. Ion injection is executed by using the gate oxide film 211 and the gate electrode 212 as a mask, so as to form n⁺ layers 204, which function as a drain electrode and a source electrode.

### (Structure of Resistors 62 and 63)

An insulating oxide film 213 is accumulated on the P-type substrate 201, and a resistive polysilicon film 214 is accumulated on the insulating oxide film 213. As a result, a polysilicon resistor is formed. One end of the resistor is an AlSi (aluminum-silicon alloy) layer, and is connected to the terminal VB, and the other end of the resistor is connected to the terminal S and the terminal R.

In FIG. 19, if a voltage exceeding the withstand voltage of the high withstand voltage n-well 206 formed on the P-type substrate 201 is applied to the upper arm control circuit, the leakage current IL1 flows from the terminal VB bonded to the high withstand voltage n-well 206 (corresponding to the terminal VBU in the case of the U-phase upper arm control circuit 31) to the terminal COMH bonded to the P-type substrate 201. The terminal VB (a first terminal) is a terminal to which the high-potential-side drive power supply voltage (VB voltage) at a floating potential is applied, and the terminal COMH (a second terminal) is a terminal connected to the ground potential.

### <Mounting Structure of Semiconductor Control Device 21>

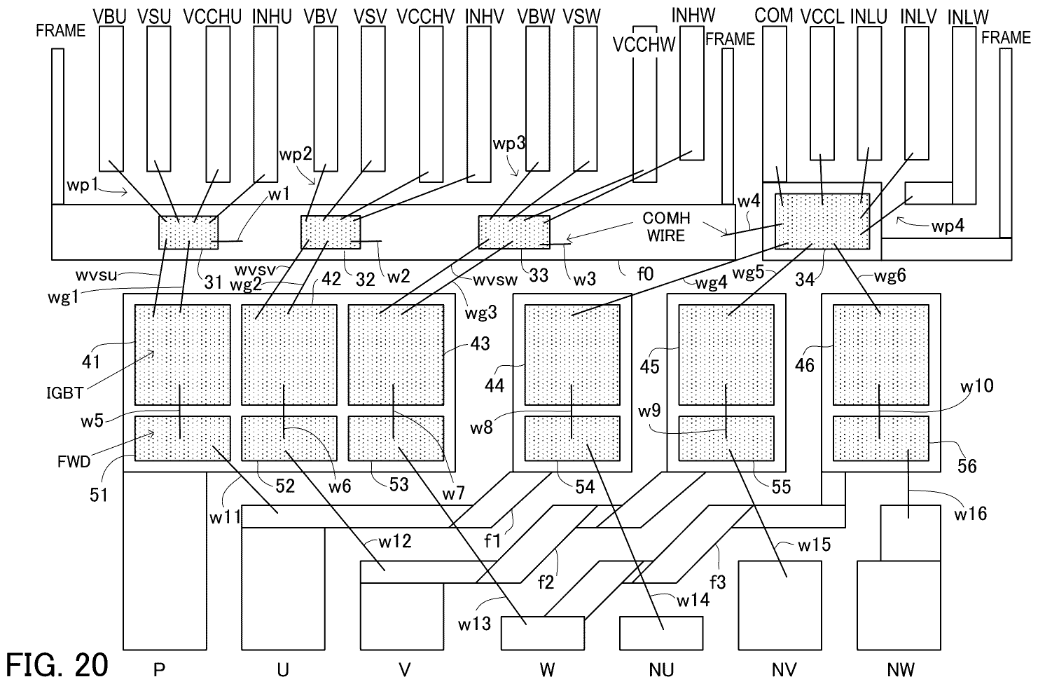

FIG. 20 illustrates an example of the mounting structure of the semiconductor control device. The upper arm control circuit 31 is connected to the terminal VBU, the terminal VSU, the terminal VCCHU, and the terminal INHU via a wire group wp1 of four wires. The upper arm control circuit 32 is connected to the terminal VBV, the terminal VSV, the terminal VCCHV, and the terminal INHV via a wire group wp2 of four wires.

The upper arm control circuit 33 is connected to the terminal VBW, the terminal VSW, the terminal VCCHW, and the terminal INHW via a wire group wp3 of four wires. The lower arm control circuit 34 is connected to the terminal COM, the terminal VCCL, the terminal INLU, the terminal INLV, and the terminal INLW via a wire group wp4 of five wires.

The upper arm control circuit 31 is connected to the emitter of the IGBT 41 via a VS wire wvsu, and to the gate of the IGBT 41 via a gate wire wg1. The upper arm control circuit 32 is connected to the emitter of the IGBT 42 via a VS wire wvsv, and to the gate of the IGBT 42 via a gate wire wg2. The upper arm control circuit 33 is connected to the emitter of the IGBT 43 via a VS wire wvsw, and to the gate of the IGBT 43 via a gate wire wg3.

The lower arm control circuit 34 is connected to the gate of the IGBT 44 via a gate wire wg4, to the gate of the IGBT 45 via a gate wire wg5, and to the gate of the IGBT 46 via a gate wire wg6.

The emitter of the IGBT 41 is connected to the anode of the FWD 51 via a wire w5, the emitter of the IGBT 42 is connected to the anode of the FWD 52 via a wire w6, and the emitter of IGBT 43 is connected to the anode of the FWD 53 via a wire w7.

The emitter of the IGBT 44 is connected to the anode of the FWD 54 via a wire w8, the emitter of the IGBT 45 is connected to the anode of the FWD 55 via a wire w9, and the emitter of the IGBT 46 is connected to the anode of the FWD 56 via a wire w10.

The anode of the FWD 51 is connected to the terminal U via a wire w11, the anode of the FWD 52 is connected to the terminal V via a wire w12, and the anode of the FWD 53 is connected to the terminal W via a wire w13.

The anode of the FWD 54 is connected to the terminal NU via a wire w14, the anode of the FWD 55 is connected to the terminal NV via a wire w15, and the anode of the FWD 56 is connected to the terminal NW via a wire w16.

In addition, the cathode of each of the FWDs 51, 52, and 53 is bonded to the terminal P via a pattern on the rear surface of the chip. The cathode of the FWD 54 is bonded to the terminal U via a frame (a lead frame) f1, the cathode of the FWD 55 is bonded to the terminal V via a frame f2, and the cathode of the FWD 56 is bonded to the terminal W via a frame f3.

In addition, the terminal COMH of each of the upper arm control circuits 31, 32, and 33 is connected to a frame f0, which is separated from the lower arm control circuit 34. In FIG. 20, these terminals COMH are connected to the frame f0 via wires w1, w2, and w3 (COMH wires) (alternatively, the rear surface of the chip of each of the upper arm control circuits 31, 32, and 33 may be bonded to the frame f0 via a conductive material). In addition, the frame f0 is connected to the terminal COMH(L) of the lower arm control circuit 34 via a wire w4 (a COMH wire).

As described above, in the semiconductor device according to the present embodiment, an upper arm control circuit executes drive control on a corresponding upper arm switching element based on the drive power supply voltage between a high-potential-side drive power supply voltage at a floating potential and a low-potential-side drive power supply voltage, and the overvoltage detection circuit detects an overvoltage state of the upper arm control circuit based on the leakage current that flows from the floating potential of the upper arm control circuit to the ground potential. Upon reception of an overvoltage detection signal, the lower arm control circuit turns on a lower arm switching element, so as to drop the drive power supply voltage of the upper arm control circuit.

As described above, by detecting the leakage current that flows from the floating potential of the HVIC to the ground potential when the HVIC is in an overvoltage state and by turning on the lower arm switching element when the leakage current exceeds a reference value, the voltage applied to the upper arm control circuit is reduced.

As a result, even when the terminal U, the terminal V, and the terminal W receive a positive surge voltage larger than a withstand voltage, it is possible to save the HVIC from destruction. In addition, a structure design in which the withstand voltage of the upper arm control circuit is set to be larger than that of the individual switching element (for example, an IGBT) is not needed.

Although an embodiment of the present embodiment has thus been described, the technological range of the present embodiment is not limited to the range described in the above embodiment. In addition, various changes or modifications may be made to the above embodiment. Furthermore, the technological range of the present embodiment includes modes to which changes or modifications have been made and includes equivalents of the modes, without departing from the gist of the present embodiment.

According to one aspect, it is possible to achieve a higher withstand voltage without needing a structural design for the surge withstand of the HVIC.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A semiconductor device configured to be controlled by a control unit, the semiconductor device comprising:
an upper arm switching element;
a lower arm switching element serially connected to the upper arm switching element;
an upper arm control circuit that executes drive control on the upper arm switching element based on an upper arm drive signal received from the control unit;
an overvoltage detection circuit that detects an overvoltage state of the upper arm control circuit and outputs an overvoltage detection signal; and
a lower arm control circuit that executes drive control on the lower arm switching element, based on a lower arm drive signal received from the control unit or based on the overvoltage detection signal.

2. The semiconductor device according to claim 1, wherein the overvoltage detection circuit detects the overvoltage state of the upper arm control circuit based on a leakage current that flows from a floating potential of the upper arm control circuit to a ground potential.

3. The semiconductor device according to claim 2, wherein upon reception of the overvoltage detection signal, the lower arm control circuit turns on the lower arm switching element.

4. The semiconductor device according to claim 3,
wherein the upper arm control circuit executes drive control on the upper arm switching element based on a drive power supply voltage between a high-potential-side drive power supply voltage at the floating potential and a low-potential-side drive power supply voltage,
wherein the semiconductor device further includes:
a first diode connected in anti-parallel with the upper arm switching element, and
a second diode connected in anti-parallel with the lower arm switching element,
wherein the semiconductor device further has:
a high-potential-side power supply terminal for connecting to a positive terminal of a power supply,
a low-potential-side power supply terminal for connecting to a negative terminal of the power supply and to the ground potential,
a low-potential-side drive power supply terminal for receiving the low-potential-side drive power supply voltage, and
an output terminal for connecting to a load,
wherein the upper arm switching element further has:
a first high potential terminal connected to a cathode of the first diode and the high-potential-side power supply terminal, and
a first low-potential terminal connected to the low-potential-side drive power supply terminal, the output terminal, an anode of the first diode, and a cathode of the second diode,
wherein the lower arm switching element further has:
a second high potential terminal connected to the first low-potential terminal of the upper arm switching element, and
a second low-potential terminal connected to an anode of the second diode and the low-potential-side power supply terminal, and
wherein when the lower arm control circuit turns on the lower arm switching element based on the overvoltage detection signal, the low-potential-side drive power supply terminal is electrically connected to the low-potential-side power supply terminal, and the drive power supply voltage drops.

5. The semiconductor device according to claim 4,
wherein the lower arm switching element has a gate,
wherein the lower arm control circuit includes:
a 2-input 1-output NOR circuit having a first input terminal, a second input terminal and an output terminal, and
an inverter circuit having an input terminal and an output terminal, and
wherein
the first input terminal of the NOR circuit receives the overvoltage detection signal,
the second input terminal of the NOR circuit receives the lower arm drive signal,
the output terminal of the NOR circuit is connected to the input terminal of the inverter circuit, and
the output terminal of the inverter circuit is connected to the gate of the lower arm switching element.

6. The semiconductor device according to claim 4,
wherein the semiconductor device further includes:
an n-well formed on a P-type substrate,
a first terminal which is bonded to the n-well and which receives the high-potential-side drive power supply voltage at the floating potential, and
a second terminal which is bonded to the P-type substrate and connected to the ground potential, and
wherein the leakage current is a current that flows, when the drive power supply voltage exceeds a withstand voltage of the n-well formed on the P-type substrate, from the first terminal to the second terminal.

7. The semiconductor device according to claim 2, wherein the overvoltage detection circuit includes:
a resistor that converts the leakage current into a voltage signal,
a reference voltage circuit that outputs a reference voltage, and
a comparator that compares the voltage signal with the reference voltage and outputs the overvoltage detection signal in response to detection of the overvoltage state of the upper arm control circuit upon determining that the voltage signal is equal to or more than the reference voltage.
